(19) United States
(12) Patent Application Publication
(10) Pub. No.: US 2019/0016319 A1
(43) Pub. Date: Jan. 17, 2019

(54) AIRCRAFT LANDING GEAR ASSEMBLY

(71) Applicant: Airbus Operations Limited, Bristol (GB)

(72) Inventors: Robert Ian THOMPSON, Bristol (GB); Keith John MACGREGOR, Bristol (GB)

(21) Appl. No.: 16/019,764

(22) Filed: Jun. 27, 2018

(30) Foreign Application Priority Data
Jun. 30, 2017 (GB) 1710569.3

(51) Int. Cl. B60T 8/18; B64C 25/00; B64C 25/34; B64C 25/42; B64C 25/60; B64F 5/60; G01G 19/10

(52) U.S. Cl. CPC B60T 8/1875; B64C 25/001; B64C 25/34; G01G 19/10; B64C 25/60; B64F 5/60; B64C 25/42

(57) ABSTRACT

An aircraft landing gear assembly (112) including a shock absorber strut (114), a bogie (120), a link assembly (124), and a movement detector (132). The shock absorber strut includes an upper and a lower telescoping parts (116, 118), the upper part being connectable to the airframe of an aircraft and the lower part being connected to the bogie. The link assembly extends between the upper and lower telescoping parts. The movement detector is arranged to detect movement of the link assembly relative to the bogie. The movement detector includes: a piston (338) slidably received within a cylinder (336), fluid which flows as a result of relative movement between the piston and the cylinder; and a pressure transducer (336) arranged to sense a local pressure change in the fluid.

### BACKGROUND OF THE INVENTION

The present invention concerns aircraft landing gear. More particularly, but not exclusively, this invention concerns an apparatus and a method for detecting aircraft weight on wheels during an aircraft landing. The invention also concerns a wing assembly and an aircraft including such a landing gear assembly.

FIG. 2 shows a typical prior art landing gear assembly 12 for an aircraft. The landing gear assembly 12 comprises a shock absorber strut 14 comprising a piston 16 received within a cylinder 18. Cylinder 18 is connected to the airframe of the aircraft. Piston 16 is at its lower end pivotally connected to a bogie 20. The bogie 20 can thereby adopt different pitch angles relative the shock absorber strut 14. A pitch trimmer 24 controls the position of the bogie 20 relative to the shock absorber strut 14 in flight. A plurality of wheels 22 are mounted on the bogie 20.

The in-flight angle of the bogie relative to the shock absorber strut (the “trail angle”) is typically set by the pitch trimmer to facilitate the retraction of the landing gear into the available space within the wheel well in the airframe. The trail angle may mean that during landing all the wheels do not touch the ground at the same time. For example, in FIG. 2 it can be seen that should the aircraft travelling in direction F land on the ground G, the rear wheel 22a will touch down in advance of the front wheel 22b.

There are various prior art methods of detecting aircraft weight on wheels during landing. The detection of weight on wheels can act as a trigger condition for the initiation of various aircraft retardation devices (for example brakes, lift dumpers, engine reverse thrust). Thus it can be understood that the sooner aircraft weight on wheels can be detected, potentially the sooner the aircraft can be slowed and, if required, brought to a stop.

One such prior art method of detecting weight on wheels involves detecting shock absorber compression. The trail angle, and the fact that the bogie is pivotally connected to the shock absorber, may mean that the shock absorber does not immediately compress, despite one or more of the wheels having touched down (i.e. despite there being weight on those wheels). For example, with reference to FIG. 2, in a landing of the aircraft on the ground G, the rear wheel 22a will touch down in advance of the front wheel 22b. However it will not be until be until there is also weight going through the front wheel 22b, and sufficient weight going through the shock absorber 14, that weight on wheels will be detected using this method. The minimum amount of weight going through the shock absorber to cause compression is known as the “breakout load”. The magnitude of the breakout load is a result of (i) a minimum pressure needed to keep the seals energised within the shock absorber and (ii) the overall shape of the shock absorber spring curve. This may result in a breakout load of several tonnes. Particularly for a low sink rate, low weight landing, the shock absorbers may not breakout immediately. This may result in late weight on wheels detection and therefore late braking in these circumstances.

Another prior art method of detecting weight on wheels involves detecting spin-up of the wheels of the aircraft. In certain conditions, for example for landings on icy runways or runways contaminated with oil, there may be a delay in the wheels spinning up after they have touched down. Therefore there may again be a delay in detecting weight on wheels.

As mentioned above, the in-air trail angle is typically set by the pitch trimmer to facilitate the retraction of the landing gear into the available space within the wheel well in the airframe. Pitch trimmers may be active or passive. Passive trimmers usually provide a force that orientates the bogie to a particular position. This can be achieved by applying a hydraulic pressure to a piston. In this case no position feedback or control function is required. Active trimmers can control the orientation of the bogie such that it can be made to adopt one of a number of positions.

In a certain prior art landing gear assembly there is provided a proximity sensor having a discrete output that indicates whether or not the bogie is at the correct trail angle to permit landing gear retraction. Movement away from this position could, during landing, be used to detect weight on wheels. However, should the pitch trimmer fail and allow the bogie to drift away from the correct trail angle during flight, aircraft weight on wheels could not be detected using this method. Therefore use of the proximity sensor in such a way would not be a sufficiently reliable method for detecting aircraft weight on wheels. Further, this method may also fail to detect weight on wheels should the aircraft land square on the bogie, such that all wheels contact the ground at once and there is limited movement of the bogie relative to the shock absorber strut.

The present invention seeks to mitigate one or more of the above-mentioned problems. Alternatively or additionally, the present invention seeks to provide an improved apparatus for detecting aircraft weight on wheels.

### SUMMARY OF THE INVENTION

The present invention provides, according to a first aspect, an aircraft landing gear assembly comprising: a shock absorber strut, a bogie, a link assembly, and a movement detector. The shock absorber strut comprises an upper and a lower telescoping parts, the upper part being connectable to the airframe of an aircraft and the lower part being connected to the bogie such that the bogie may adopt different pitch angles. The link assembly extends between the upper and lower telescoping parts, such that relative movement between the upper and lower telescoping parts causes relative movement between parts of the link assembly. The movement detector is arranged to detect movement of the link assembly. The movement detector comprises: a piston slidably received within a cylinder, arranged such that relative movement between the link assembly and the bogie causes relative movement of the piston within the cylinder, fluid which flows as a result of relative movement between the piston and the cylinder, and one or more pressure transducers arranged to sense a pressure change in the fluid. Relative movement between the link assembly and the bogie is detected by the one or more pressure transducers detecting a change in pressure, which may be a local change in pressure and/or a transient change in pressure, due to movement of the piston within the cylinder.

Embodiments of the aircraft landing gear assembly of the first aspect may provide several benefits over the aforementioned prior art. Firstly, the assembly does not rely only on shock absorber compression before weight on wheels can be detected. Similarly, the assembly does not rely only on the movement of the bogie relative to the shock absorber strut for detection of weight on wheels. By the use of pressure change to detect movement, the movement detector is arranged to detect movement of the link assembly relative to the bogie irrespective of their relative initial positions. The assembly therefore need not rely on the pitch trimmer bringing the bogie to a predetermined position in order to detect aircraft weight on wheels during landing, because the movement detector can detect movement of the link assembly with respect to the bogie regardless of the initial position of the link assembly and the bogie. The aircraft landing gear assembly according to the present invention advantageously detects aircraft weight on wheels due to compression of the shock absorber (which causes movement of the link assembly) and/or a change in trail angle during landing, in spite of failure conditions of the pitch trimmer.

It will be appreciated that there may be certain arrangements of the assembly in which no relative movement of the link assembly and bogie occurs at a particular landing angle because the movement of the bogie cancels out the movement of the link assembly when the shock absorber compresses. However it has been found that the assembly can be arranged to mitigate or eliminate the possibility of this happening under most foreseeable circumstances.

The upper part (or the lower part) of the shock absorber strut may be a cylinder part. The lower part (or the upper part) of the shock absorber strut may be a piston part or a slider part. The piston part or slider part may be arranged to be received within the cylinder part. This may permit telescopic movement such that the shock absorber strut can vary in length. The length of the shock absorber strut may vary depending on the amount of load applied to the shock absorber strut in the direction of the longitudinal axis of the shock absorber strut. The internal cavity formed by the upper and lower parts of the shock absorber strut may contain gas, which may be contained under pressure. The gas may act as a spring and may at least partially support the aircraft weight when on the ground. The cavity may also contain a volume of hydraulic fluid (e.g. oil). The hydraulic fluid may be forced through restrictors to provide damping (i.e. to control the rate of movement of the slider).

The link assembly, being connected between the upper and lower telescoping parts of the shock absorber strut, is caused to move when the shock absorber strut compresses or extends. Therefore when load is applied to (or removed from) the shock absorber strut, for example during landing of an aircraft, the link assembly will be caused to move. In use the link assembly and the bogie may have an initial relative position at a given time. The given time may be after the landing gear assembly has been deployed for landing and before the aircraft has touched down. The link assembly, the bogie and the movement detector may be so arranged that the movement detector detects relative movement, from an initial position, between the link assembly and the bogie, irrespective of the initial positions of the link assembly and the bogie. The link assembly may extend between, and be directly connected to, the upper and lower telescoping parts.

The landing gear may comprise a torque link assembly. The torque link assembly may be arranged to resist rotation of the upper part of the shock absorber strut relative to the lower part of the shock absorber strut, about the longitudinal axis of the shock absorber. The landing gear may comprise a false link assembly (sometimes referred to as a slave link assembly). The false link assembly may not itself be arranged to resist rotation. The false link assembly may provide an alternative route for the electrical and hydraulic dressings that connect to wheel mounted systems (brakes, tachometers, tyre pressure sensors etc.) segregated from the route available over the torque link assembly. The link assembly (whose relative movement is detected) may be either the torque link assembly or the false link assembly. In some embodiments the movement of more than one link assembly relative to the bogie may be detected.

The movement detector and/or link assembly may be positioned fore or aft of the shock absorber strut. Positioning the movement detector and/or link assembly aft of the shock absorber strut may be advantageous as it may at least be partially shielded by the shock absorber strut during flight, for example against bird strike.

The link assembly may comprise an upper arm and a lower arm. The upper arm may be pivotally connected to the upper part of the shock absorber strut. The lower arm may be pivotally connected to the lower part of the shock absorber strut. The upper and lower arms may be pivotally connected to each other at a hinge location. When the shock absorber strut is compressed, the hinge location may be forced outwards and away from the shock absorber strut. The upper arm may be directly connected to the upper part of the shock absorber strut (i.e. not via any other link arms or the like). The lower arm may be directly connected to the lower part of the shock absorber strut.

The movement detector may be connected at one end to the link assembly. That end of the movement detector may be attached to the link assembly at a location that, along the length of the link assembly when at its most open, is closer to the hinge location than to the either end of the link assembly. The movement detector may be mounted to the link assembly at, or directly adjacent to, the hinge location of the link assembly. The movement detector may be mounted to the link assembly at the hinge location. For example, the upper arm may be pivotally connected to the lower arm by an axial pin extending through the upper arm and lower arm. The movement detector may be mounted at the axial pin, for example being mounted on the axial pin.

The movement detector may be arranged to detect movement of the upper arm and/or the lower arm relative to the bogie. The movement detector may be mounted to the upper arm and/or lower arm. The movement detector may be pivotally mounted at one end to the upper arm and/or lower arm. The movement detector may be mounted to the upper and/or lower arm at a location between the two ends of the upper arm and/or lower arm. The movement detector may be arranged to detect the angle of the upper arm and/or the lower arm relative to the bogie.

The bogie may comprise a bogie beam extending fore and aft. The bogie may comprise one or more axles. One or more wheels may be mounted on the one or more axles. For example, the bogie may comprise two axles, or three axles, each axle having two wheels. The shock absorber strut may be pivotally connected to the bogie. The movement detector may be mounted at one end to the bogie. The movement detector may be mounted to the bogie fore or aft of the location at which the shock absorber strut connects to the bogie.

The movement detector may comprise a member, or series of members, connected to and extending between the link assembly and the bogie. The movement detector may detect movement of one of its ends relative to the other. The movement detector may detect linear movement or rotational movement.

The movement detector may be connected to, and extend between, the link assembly and the bogie. The cylinder may be pivotally connected to the link assembly or bogie. The piston may be pivotally connected, via a piston rod, to the link assembly or bogie.

The movement detector may provide an output, for example an output signal, in dependence on movement of the torque link relative to the bogie. The output signal may be one that indicates in a binary manner whether or not there has been detection of movement of the torque link relative to the bogie. It may be the case that detection of movement by the movement detector is deemed to have occurred when the movement detector provides an output. A control system may be provided to interpret the output in order to determine whether movement has been detected. The output may be in the form of an electrical signal. The control system may comprise, or consist of, a signal processor. The control system may be integral to the movement detector. The control system may be remote from the movement detector. The control system may be an aircraft control system, for example being located in another part of the aircraft remote from the landing gear. The control system may provide an energising current and/or voltage to the sensors such that they can function. It will be understood that the control system may process the signals received from the sensor and may output a modified signal. The control system need not necessarily have control of any particular external or physical operations.

The movement detector may be arranged to output a particular form of signal, for example a pulse, upon movement of the link assembly relative to the bogie. The control system may arranged to determine that movement has been detected due to receipt of that particular signal.

The movement detector may be arranged to detect movement when the movement, or rate of movement, of the link assembly relative to the bogie exceeds a threshold amount. The movement detector may be arranged to output a signal, for example a pulse, when the movement, or rate of movement, of the link assembly relative to the bogie exceeds a threshold amount.

The movement detector may be arranged to detect the position of the link assembly relative to the bogie. The movement detector may be arranged to output a signal which corresponds to the position of the link assembly relative to the bogie. The control system may arranged to determine that movement has been detected due to a change in the signal.

The movement detector may be arranged to detect the direction of movement, rate of movement and/or acceleration of the link assembly relative to the bogie. The movement detector may be arranged to output a signal from which direction of movement, rate of movement and/or acceleration can be determined. The control system may arranged to determine direction of movement, rate of movement and/or acceleration from the signal.

It will be understood that the signal may take various forms. For example the signal could be a direct or alternating current. Movement of the link assembly relative to the bogie could cause a temporary change in the voltage, current and/or frequency of the signal. Alternatively or additionally, the voltage, current and/or frequency could be related to the position of the link assembly relative to the bogie. In other embodiments the signal could be an analogue or digital waveform which encodes information, for example a true/false indication or a numerical value, for example a measurement of distance or angle.

The movement detector, or alternatively the associated control system, may be arranged to generate a binary output indicating whether or not aircraft weight on wheels is detected. For example the output may be an “on” signal when aircraft weight on wheels is detected and an “off” signal when aircraft weight on wheels is not detected.

The movement detector may comprise one or more sensors, in addition to the one or more pressure transducers. The sensors may sense an action which occurs in response to movement of the link assembly relative to the bogie beam. The sensors may sense the position of one or more elements. The position of those elements may correspond to the position of the torque link relative to the bogie beam. The output from the sensors may be used as an additional indication of whether the link assembly has moved relative to the bogie. The output may be in the form of an electrical signal. The control system may be configured to interpret the signal from the sensors in order to determine whether movement has been detected.

The sensors may be arranged such that they provide an output, from which movement of the link assembly relative to the bogie can be determined to have occurred, when the movement, or rate of movement, exceeds a threshold amount.

The same sensors, or one or more additional sensors, may also provide an output which may be used to determine direction of movement, rate of movement and/or acceleration of the link assembly relative to the bogie. The control system may also be configured to interpret the signal from the sensors in order to determine the direction of movement, rate of movement and/or acceleration.

The landing gear assembly may comprise a pitch trimmer arranged to move the bogie so as to adopt a particular trail angle. The pitch trimmer may be active or passive.

The pitch trimmer may be provided in addition to the movement detector. Alternatively, the movement detector may be formed as a part of the pitch trimmer

The cylinder may comprise a first chamber. The first chamber may be in fluid communication with a second chamber. The cylinder may comprise the second chamber. The first chamber and the second chamber may be separated by the piston. The first chamber and the second chamber may enclose a volume of fluid that is able to flow between the first chamber and the second chamber. The fluid is preferably a hydraulic fluid. The fluid is preferably a liquid. The fluid may be substantially incompressible. The first chamber and the second chamber may be in fluid communication through a flow restricted channel The one or more pressure transducers may be arranged to sense a pressure change occurring in the first chamber and/or second chamber.

One or more pressure relief channels may be arranged to permit (i) fluid flow from the first chamber into the second chamber when the pressure in the first chamber exceeds a first threshold pressure relative to the pressure in the second chamber and (ii) fluid flow from the second chamber into the first chamber when the pressure in the second chamber exceeds a second threshold pressure relative to the pressure in the first chamber. Movement may be detected by the one or more pressure transducers detecting a transient change in pressure in the first chamber or second chamber due to a movement of the piston within the cylinder.

A movement of the piston in the direction of the first chamber may cause the volume of the first chamber to decrease and the volume of the second chamber to increase by a corresponding amount, or vice versa. The pressure of the fluid in the first chamber may thereby increase relative to the pressure of the fluid in the second chamber, or vice versa. The flow restricted channel may reduce the rate at which the fluid can flow between the first and second chambers. The flow restricted channel may thereby reduce the rate at which the pressure difference between the first chamber and second chamber can equalise.

It will be understood that equalisation of pressure between the first chamber and second chamber is never instantaneous, regardless of the width of the channel, there must at some point in time be a difference in the fluid pressure in the two chambers in order for there to be any movement of fluid between them. However, the skilled person will understand that there may be a continued build-up of pressure if the rate at which the pressure increases due to compression by the piston is not matched by the rate at which the pressure decreases due to fluid flow into the other chamber.

The flow restricted channel may be configured to enable the pressure in the first chamber to increase relative to the pressure in the second chamber, and alternatively the pressure in the second chamber to increase relative to the pressure in the first chamber, before the pressures in the first chamber and second chamber can equalise. A more restricted flow of fluid between the first chamber and second chamber may lead to a quicker build-up of pressure in the compressed chamber. A more restricted flow may therefore make for a more sensitive movement detector.

The build-up of pressure in the first or second chamber may be detected by the one or more pressure transducers. The signal from the one or more pressure transducers may therefore change in correspondence with this increase. From this change it may be determined by a signal processor that movement has occurred. The signal processor may be located in or proximate the cylinder, or may be incorporated in the aircraft control system. The change in the signal is transient because, provided the piston finishes its movement, the pressure between the first chamber and the second chamber will equalise. The signal from the pressure transducer may therefore return to a ‘baseline’ reading after a certain time as the pressure difference decays. The signal may therefore be considered to be in the form of a pulse. The equalisation may occur only via the flow restricted channel, but it may also occur via the pressure relief channel if the threshold pressure of the relevant pressure relief valve is reached.

The signal processor may be arranged to determine that movement has occurred when the pressure in the first chamber or the second chamber has increased only by a certain threshold pressure. The threshold pressure is preferably lower than the threshold pressures of the pressure relief valve. Alternatively or additionally, the transducers may have a trigger pressure, i.e. a threshold pressure at which the transducer provides a signal indicating that pressure is detected. It may be the meeting of a threshold pressure, or the triggering of the transducer, that is used to provide an indication of aircraft weight on wheels. The threshold or trigger pressure may be set such that changes in pressure due to vibrations, and/or in-flight drift of the trail angle, do not meet the threshold. This may help mitigate false indications of aircraft weight on wheels.

It will be appreciated that, alternatively or additionally to pressure increase, decrease in pressure in the first or second chamber may be measured by the transducers. Pressure decrease may be used as an indication of aircraft weight on wheels.

The flow restricted channel may include one or more locations at which flow is restricted, for example flow being restricted locally to a great extent than in other regions of the flow restricted channel The flow restricted channel may restrict flow at only one or more particular flow restricted locations, for example the flow restricted channel may comprise a flow restrictor device. The flow restrictor may itself further comprise a channel of reduced cross-sectional area. The movement detector may comprise two pressure transducers. A first pressure transducer may be arranged to measure the pressure in the first chamber. The first pressure transducer may measure the pressure at one side of the flow restricted location. A second pressure transducer may be arranged to measure the pressure in the second chamber. The second pressure transducer may be arranged to measure the pressure at the other side of the flow restricted location. An advantage of using two transducers to get an indication of pressure in each chamber separately is that it may be possible to determine the direction in which the piston moves, and therefore the direction of movement of the bogie relative to the link assembly.

The flow restricted channel may comprise two flow restricted locations. At least one pressure transducer may be arranged to measure the pressure between the two flow restricted locations. The movement detector may further comprise a first non-return channel connecting the first chamber with the flow restricted channel at a location between the two flow restricted locations. The first non-return channel may comprise a non-return valve arranged to only permit fluid flow from the first chamber into the flow restricted channel. The movement detector may further comprise a second non-return channel connecting the second chamber with the flow restricted channel at a location between the two flow restricted locations. The second non-return channel may comprise a non-return valve arranged to only permit fluid flow from the second chamber into the flow restricted channel

The pressure transducers may be provided in duplicate such that the pressure at a particular location or in a particular channel and/or chamber is measured by two pressure transducers. This may provide improved system reliability in case of failure of a pressure transducer.

When the piston moves and the pressure increases in the first or second chamber, the pressure between the two flow restricted locations may also increase because fluid will be forced through the first or second non-return valve. The single pressure transducer may thereby register an increase in pressure in either the first or the second chamber. The pressure between the two flow restricted locations may eventually equalise with the two chambers. If the pressure in the first (or second) chamber increases to the extent that a pressure relief valve is opened, then the pressure in the two chambers may equalise at a quicker rate than the fluid stuck between the two flow restricted locations of the flow restricted channel

The various channels and valves mentioned above may be located in the piston. Particularly the pressure relief channels, the flow restricted channel, and/or the non-return channels may be located in the piston.

The movement detector preferably comprises a piston rod. The piston rod may extend along the longitudinal axis of the cylinder. The piston rod preferably extends through both chambers so that the total volume of the first and second chambers does not change as the piston moves.

The piston rod may comprise one or more channels extending therethrough. The channels may put the one or more pressure transducers in fluid communication with the first and/or second chambers. The channels may put the pressure transducers in direct fluid communication with the first and/or second chambers, or the channels may connect to other channels such as the flow restricted channel.

The movement detector may comprise a body mounted to the cylinder. Preferably the body is detachably mounted. The various channels and valves mentioned above may be located in the body. Particularly the pressure relief channels, the flow restricted channel, and/or the non-return channels may be located in the body. Locating the channels and valves in a detachable body may make replacement, repair and/or manufacture of these elements of the system easier and/or more convenient.

The average pressure of the fluid in the movement detector is preferably sufficient to energise dynamic seals in the movement detector, and may not be substantially higher. Preferably the pressure is sufficient to maintain a differential pressure across the dynamic seals under substantially all foreseeable operating conditions. Preferably the pressure is slightly above that of the local atmosphere. Maintaining such a pressure, and keeping the device completely filled with hydraulic fluid, may help reduce moisture ingress. By way of example the pressure may be about 100 psi.

The movement detector may comprise an accumulator arranged to maintain the average pressure of the volume of fluid. The accumulator may act to top-up the fluid in the chambers should fluid be lost, for example by leaking through seals. A non-return valve and/or flow restrictor may be provided between the accumulator and the chambers to prevent or reduce back flow into the accumulator. In use, the accumulator may or may not be connected to the aircraft hydraulic system.

The present invention provides, according to a second aspect, a method of detecting aircraft weight on wheels during a landing of an aircraft. The aircraft comprises a control system and a landing gear assembly. The landing gear assembly comprises: a shock absorber strut, a bogie, a link assembly, and a movement detector. The shock absorber strut comprises an upper and a lower telescoping parts, the upper part being connected to the airframe of the aircraft and the lower part being connected to the bogie such that the bogie may adopt different pitch angles. The link assembly extends between the upper and lower telescoping parts, such that relative movement between the upper and lower telescoping parts causes relative movement between parts of the link assembly. The bogie supports at least one wheel on at least one axle. The movement detector comprises: a piston slidably received within a cylinder, wherein movement of the piston within the cylinder causes fluid to flow in the movement detector; and one or more pressure transducers arranged to sense a local pressure change in the fluid. In accordance with the method, the link assembly has an initial position relative to the bogie at a point in time that is after the landing gear assembly has been deployed for landing and before the aircraft has touched down. The method comprises a step of the link assembly moving relative to the bogie during touchdown of the least one wheel thereby causing the piston to move within the cylinder and there to be a transient change in pressure in the fluid. The method comprises a step of the one or more pressure transducers detecting the change in pressure. The method comprises a step of the control system receiving a signal from the one or more pressure transducers, the signal being indicative of the change in pressure. The method comprises a step of the control system determining, on the basis of the signal, that there is aircraft weight on wheels.

The landing gear assembly may be a landing gear assembly according to the first aspect of the invention and may incorporate any features set out in relation to the first aspect.

The step of detecting the movement of the link assembly relative to the bogie may comprise the movement detector providing an output from which it can be determined that the torque link has moved relative to the bogie. The control system is in communication with the movement detector such that it receives a signal corresponding to the output.

The step of detecting the movement of the link assembly relative to the bogie may comprise generating a particular form of signal, for example a pulse, upon movement of the link assembly relative to the bogie. The control system may determine weight on wheels due to receipt of the particular form of signal. The step of detecting the movement of the link assembly relative to the bogie may comprise generating the particular form of signal when the movement, or rate of movement, of the link assembly relative to the bogie exceeds a threshold amount.

The step of detecting the movement of the link assembly relative to the bogie may additionally comprise generating a signal which corresponds to the position of the link assembly relative to the bogie, the signal changing due to the change in the position of the link assembly relative to the bogie. The signal received by the control system may thereby comprise the indication of the position of the link assembly relative to the bogie. The control system may use a change in the signal received as an additional indication of weight on wheels.

The method may comprise generating a signal which contains information on the direction of movement, rate of movement and/or acceleration of the link assembly relative to the bogie. The control system may determine the direction of movement, rate of movement and/or acceleration from the signal.

The step of detecting movement of the link assembly relative to the bogie may comprise detecting movement of the link assembly away from its initial position relative to the bogie. The initial position of the link assembly relative to the bogie may be the position of the link assembly relative to the bogie at a point in time when the aircraft is at a predetermined altitude above ground level. The method may include a step of the control system ascertaining the position of the link assembly relative to the bogie at a predetermined altitude above ground level. The altitude may be determined by, for example, a radar altimeter. The initial position of the link assembly relative to the bogie may be the position of the link assembly relative to the bogie when the aircraft is at a predetermined time prior to an estimated time of touch down. The method may include a step of the control system ascertaining the estimated time of touchdown. The initial position of the link assembly relative to the bogie may be the position of the link assembly relative to the bogie when the aircraft is at a predetermined position. The position may be determined by the aircraft positioning system, for example using GPS. The location may be, for example, the runway threshold.

The method may comprise zeroing the movement detector such that the initial position of the link assembly relative to the bogie corresponds to a zero value. The zeroing may comprise the control system assigning a zero value to a level, value, amount, etc. of the signal. For example, a zero value may be assigned to a particular amount of voltage. It may be that the zeroing of the movement detector is performed electronically in a control system by recording a value that corresponds to the initial position of the link assembly relative to the bogie, and treating that recorded value as the zero value, without the control system actually converting it to a value equal to zero.

One end of the movement detector, for example one end of the cylinder, may be connected to the link assembly. An opposing end of the movement detector, for example a free end of the piston rod, may be connected to the bogie.

The step of the link assembly moving relative to the bogie during touchdown might include the point on the link assembly to which the cylinder is attached moving towards (or away from) the point on the bogie to which the piston rod is attached. The movement of the link assembly with respect to the bogie may thus lead to the piston being moved into (or out of) the cylinder. This in turn may result in compression of the second chamber (or first chamber). The pressure of fluid in the second chamber (or first chamber) my therefore rise.

The increase in pressure may be detected by a pressure transducer which is in communication with the control system. The control system may therefore be receiving a signal from the pressure transducer which corresponds to the pressure detected by the pressure transducer. Fluid may not be able to flow into the first chamber (or second chamber) via the flow restricted channel fast enough to equalise the pressure in the first and second chambers. The pressure may therefore continue to increase. Once the pressure has reached a predetermined level the control system may determine, on the basis of the pressure signal from the pressure transducer, that the movement of the bogie relative to the link assembly is sufficient for it to be an indication of aircraft weight on wheels.

Should the pressure in the second chamber (or first chamber) continue to rise past the threshold pressure of the second pressure relief valve (or first pressure relief valve), the second pressure relief valve (or first pressure relief valve) may open to hasten the equalisation of pressure and allow more rapid movement of the piston within the cylinder.

It will be appreciated that instead of using increase in pressure in a chamber, decrease in pressure could alternatively or additionally be used to determine aircraft weight on wheels. Whether there is extension or compression of the movement detector during landing may depend on the position of the movement detector, the orientation of the movement detector, and/or the trail angle.

The present invention provides, according to a third aspect, a method of slowing an aircraft, the method comprising the steps of: detecting whether there is aircraft weight on wheels according to the method of the second aspect of the invention, and deploying at least one means of slowing an aircraft when the control system determines there to be aircraft weight on wheels. The means of slowing an aircraft may, for example, include reverse thrust, lift dumpers and/or wheel braking. The method may more generally be a method of triggering the deployment of a means for slowing an aircraft.

In another aspect of the invention, there is provided an aircraft comprising a landing gear assembly according to any other aspect of the invention. The aircraft may comprise more than one landing gear assembly in accordance with the present invention. There may be one or more such landing gear assemblies located on opposite sides of the aircraft.

The aircraft may be a commercial aircraft, for example an aircraft configured to transport more than 50 passengers, for example more than 100 passengers, for example more than 200 passengers or an equivalent cargo load. The aircraft may be a commercial passenger aircraft. The aircraft may be a fixed wing aircraft.

In another aspect of the invention, there is provided a movement detector comprising: a piston slidably received within a cylinder, arranged such that relative movement between the link assembly and the bogie causes relative movement of the piston within the cylinder; fluid which flows as a result of relative movement between the piston and the cylinder; and one or more pressure transducers arranged to sense a pressure change in the fluid. Relative movement between the link assembly and the bogie is detected by the one or more pressure transducers detecting a change in pressure, which may be a local change in pressure and/or a transient change in pressure, due to movement of the piston within the cylinder.

The movement detector may comprise any of the features set out in relation to any other aspect of the invention, particularly the first and second aspects of the invention.

The present invention may provide, more generally, an aircraft landing gear assembly comprising: a shock absorber strut, a bogie, a link assembly, and a movement detector. The shock absorber strut comprises an upper and a lower telescoping parts, the upper part being connectable to the airframe of an aircraft and the lower part being connected to the bogie such that the bogie may adopt different pitch angles. The link assembly extends between the upper and lower telescoping parts, such that relative movement between the upper and lower telescoping parts causes relative movement between parts of the link assembly. In use the link assembly and the bogie have an initial relative position at a given time, and the movement detector is arranged to detect movement of the link assembly relative to the bogie irrespective of the initial relative position of the link assembly and the bogie. The movement detector may not necessarily comprise the piston and cylinder arrangement of the first aspect.

The movement detector may be used in other aeronautical applications. In an aspect of the invention there may be provided an aircraft comprising a movement detector as set out above. There may also be non-aeronautical, for example automotive, applications for the movement detector.

It will of course be appreciated that features described in relation to one aspect of the present invention may be incorporated into other aspects of the present invention. For example, the method of the invention may incorporate any of the features described with reference to the apparatus of the invention and vice versa.

The term ‘or’ shall be interpreted as ‘and/or’ unless the context requires otherwise. It will be understood that phrases to the effect of “movement of component x relative to component y”, “movement of component y relative to component x”, “relative movement of components x and y”, “movement of component x with respect to component y”, etc. are equivalent, are used interchangeably, and do not imply a particular component is stationary in a particular reference frame unless otherwise stated.

Alternative embodiments of a movement detector are described and claimed in both (a) UK patent application entitled “Aircraft Landing Gear Assembly” with agent's reference “P026754GB” and marked with the reference “12211-GB-NP” in the header of the patent specification as filed and (b) UK patent application entitled “Aircraft Landing Gear Assembly” with agent's reference “P026755GB” and marked with the reference “12212-GB-NP” in the header of the patent specification as filed, each application having the same filing date as the present application. The contents of those applications are fully incorporated herein by reference. The claims of the present application may incorporate any of the features disclosed in that patent application. In particular, the claims of the present application may be amended to include features relating to movement detector as set forth in the claims of either of the aforementioned other patent applications.

### DESCRIPTION OF THE DRAWINGS

Embodiments of the present invention will now be described by way of example only with reference to the accompanying schematic drawings of which:

FIG. 1 shows a side view of an aircraft comprising a landing gear assembly;

FIG. 2 shows a side view of a prior art landing gear assembly;

FIG. 3 shows a side view of a landing gear assembly according to a first embodiment of the invention prior to touchdown;

FIG. 4 shows a side view of a landing gear assembly according to a first embodiment of the invention after touchdown and before shock absorber compression;

FIG. 5 shows a side view of a landing gear assembly according to a first embodiment of the invention after shock absorber compression;

FIG. 6 shows a flow chart of a method of detecting aircraft weight on wheels according to a second embodiment of the invention;

FIG. 7 shows a cross-sectional view of a movement detector according to a third embodiment of the invention;

FIG. 8 shows an enlarged cross-sectional view of the piston of the movement detector according to a third embodiment of the invention;

FIGS. 9 to 12 show sequential cross-sectional views of the movement detector according to a third embodiment of the invention during movement;

FIG. 13 shows a cross-sectional view of a movement detector according to a fourth embodiment of the invention;

FIG. 14 shows an enlarged cross-sectional view of the detachable body of the movement detector according to a fourth embodiment of the invention;

FIG. 15 shows a cross-sectional view of a movement detector according to a fifth embodiment of the invention;

FIG. 16 shows an enlarged cross-sectional view of the detachable body of the movement detector according to a fifth embodiment of the invention; and

FIGS. 17 to 19 show sequential cross-sectional views of the movement detector according to a fifth embodiment of the invention during movement.

### DETAILED DESCRIPTION

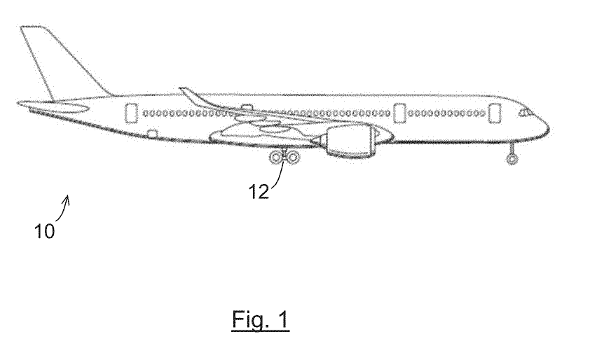

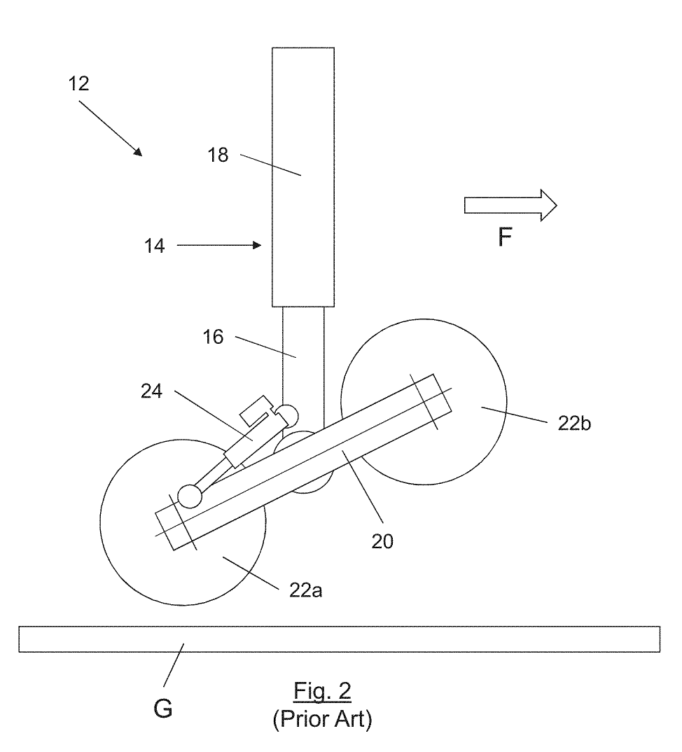

FIG. 1 shows an aircraft 10 comprising a main landing gear 12, the aircraft being of a type that may be employed as the aircraft with which the methods and apparatuses of any of the illustrated embodiments may be used. The aircraft 10 thus includes a landing gear assembly 12 including a bogie, which is mounted on the lower end of the landing gear leg in such a way that the bogie may adopt different pitch angles.

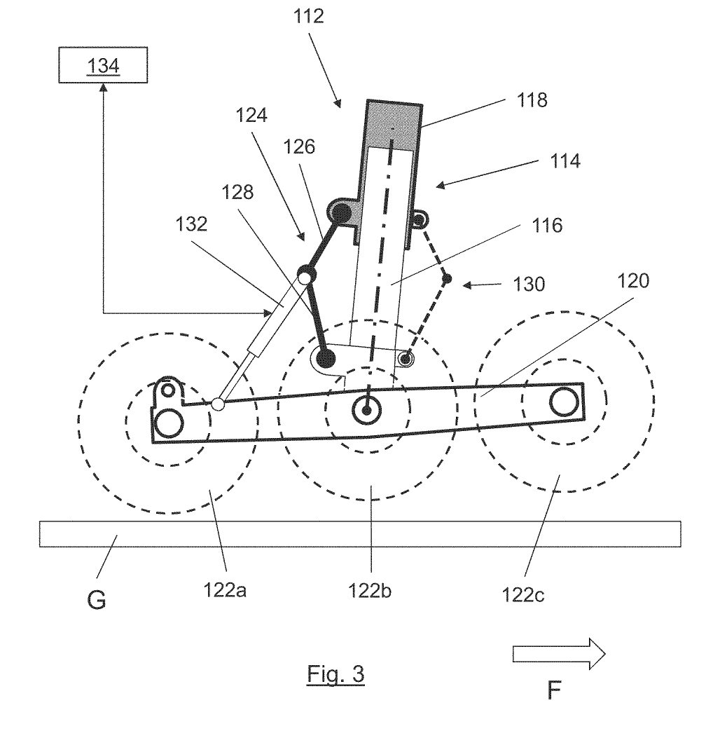

FIG. 3 shows an aircraft landing gear assembly 112 according to a first embodiment of the invention. The landing gear assembly 112 comprises a shock absorber strut 114 comprising a piston 116 received within a cylinder 118. Cylinder 118 is connected to the airframe of an aircraft. The direction of the front of the aircraft is indicated by arrow F. Piston 116 is at its lower end pivotally connected to a bogie 120. The bogie 120 can thereby adopt different pitch angles relative the shock absorber strut 114. A pitch trimmer (not shown) controls the position of the bogie 120 relative to the shock absorber strut 114 in flight.

A plurality of wheels 122 are mounted on the bogie 120. In this embodiment three pairs of wheels 122a, 122b, 122c are mounted to bogie 120 by three axles. A link assembly 124 in the form of a torque link connects the cylinder 118 and the piston 116 of the shock absorber strut. The link assembly 124 comprises an upper arm 126 which is pivotally mounted to the cylinder 118 and a lower arm 128 which is pivotally mounted to the piston 116. The upper arm 126 and lower arm 128 are pivotally attached to each other at a hinge location. The link assembly 124 acts against rotational movement of the piston 116/bogie 120 relative to the cylinder 118/airframe. FIG. 3 also shows a second link assembly 130 in the form of a false link.

A movement detector 132 extends between the link assembly 124 and the bogie 120. One end of the movement detector is pivotally connected to the link assembly 124 at the hinge location. An opposing end of the movement detector 132 is pivotally connected to the bogie 120 proximate the aft end of the bogie 120.

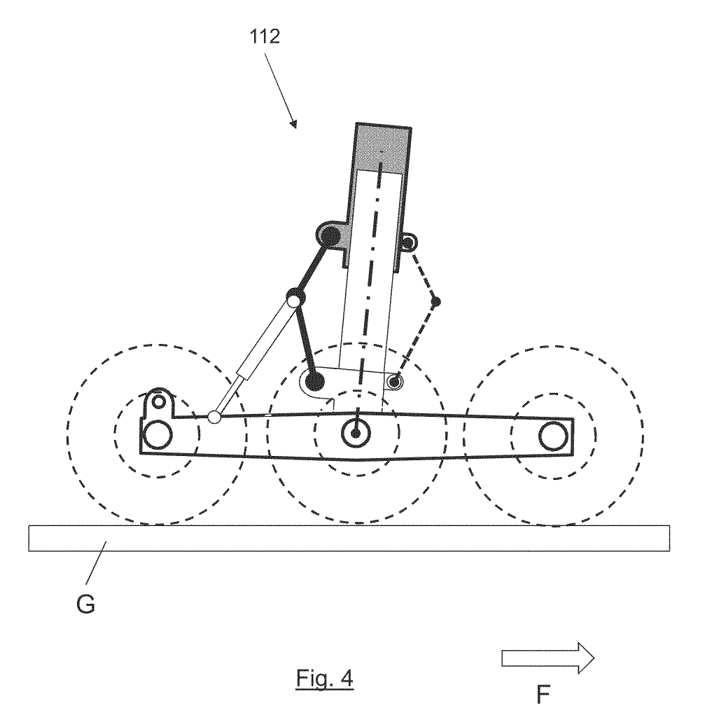

The landing gear assembly 112 of the first embodiment has a trail angle of less than 10 degrees. During landing of the aircraft the aft pair of wheels 122a touchdown first. The bogie 120 subsequently pivots around the bottom of the shock absorber strut 114 until the centre 122b and front 122c pair of wheels have also touched down. At which point the bogie 120 is oriented substantially parallel to the ground G. In the present arrangement, the movement detector 132 is therefore compressed, as shown in FIG. 4.

Until the centre 122b and front 122c pair of wheels have touched down, there is unlikely to be enough aircraft weight going through the shock absorber strut 114 to cause it to compress. The link assembly 124 will therefore remain stationary relative to the airframe during this initial movement of the bogie 120 relative to the link assembly 124.

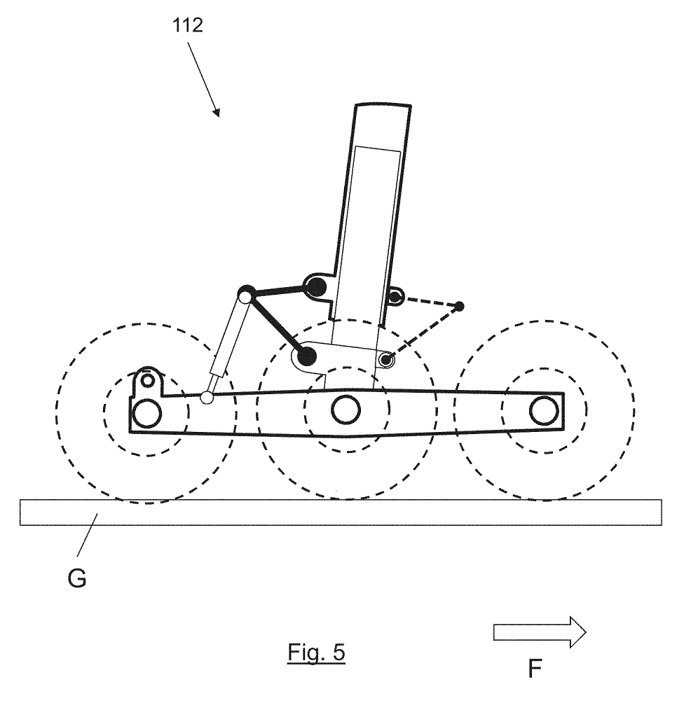

Thereafter, the shock absorber strut 114 begins to compress due to the weight of the aircraft. The link assembly 124 again moves relative to the bogie 120. The hinge location of the link assembly 124 moves aft and downwards. In the present arrangement this causes further compression of the movement detector 132, as shown in FIG. 5.

Compression of the movement detector 132 is detected by sensors, at least some of which being pressure transducers, in the movement detector 132. The sensors are in communication with a control system 134 of the aircraft. Upon compression of the movement detector, the sensors output a signal from which the control system 134 can determine that (i) there has been movement of the link assembly relative to the bogie and (ii) therefore there is aircraft weight on wheels.

In the event of a flat landing of the bogie 120, in which all pairs of wheels 122 touchdown at substantially the same time, it will be seen that movement is still detected due to shock absorber 114 compression, despite there being no or negligible pivotal movement of the bogie 120 about the shock absorber strut 114.

The aircraft may land with a negative trail angle, such that the front pair of wheels 122c touch down before the rear pair of wheels 122a. In this case the aft portion of the bogie 120 will initially pivot away from the link assembly 124. Thus the movement detector 132 extends in length until the bogie 120 is parallel to the ground. Subsequent shock absorber 114 compression then moves the link assembly 124 back towards the point on the bogie 120 where the movement detector is attached, thus causing compression of the movement detector 132. Both such movements could be used to detect aircraft weight on wheels, and could also be used to detect the time of shock absorber 114 compression.

In alternative embodiments the movement detector 132 may be mounted between the forward portion of the bogie 120 and the false link 130. In other alternative embodiments the movement detector 132 may be connected to the lower arm 128 below the hinge location.

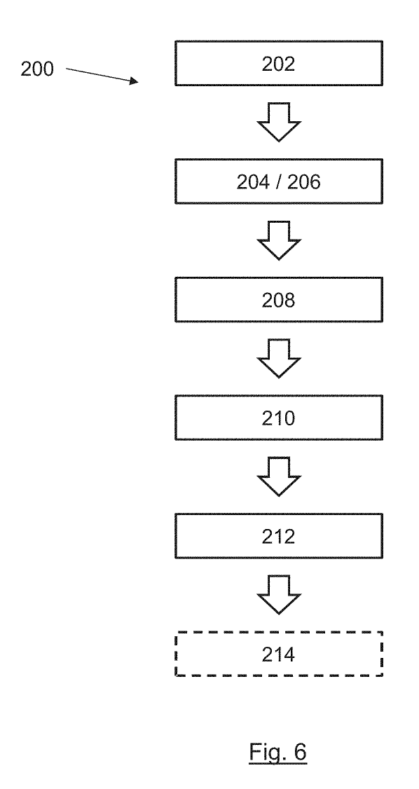

A method 200 of detecting aircraft weight on wheels will now be described according to a second embodiment of the invention and with reference to FIG. 6. The method will be described with reference to an aircraft landing gear assembly according to the first embodiment.

The method begins subsequent to deploying (lowering) the aircraft landing gear from the aircraft wheel well. However the method may include a step of lowering the aircraft landing gear. The first step includes the control system 134 determining 202, from a radar altimeter, whether the altitude is below a predetermined value, in this example whether the altitude is below 10 feet. Provided the altitude condition is met, i.e. provided the altitude is below 10 feet, the control system 134 is configured to use the signal received from the movement detector 132 to determine whether there is aircraft weight on wheels. In embodiments in which the movement detector detects positon, the method may include and additional step of zeroing the movement detector and/or a step of taking a reading of the initial position of the movement detector (which corresponds to the initial position of the link assembly 124 relative to the bogie 120).

The method subsequently comprises a step of at least one wheel of the aircraft touching down 204 on the ground and concurrently the link assembly 124 moving 206 relative to the bogie 120. Depending on the orientation of the bogie 120 relative to the ground immediately prior to touchdown, and whether there is any equipment failures for example deflation of one or more of the tyres, the link assembly 124 moves relative to the bogie 120 by (i) the bogie 120 pivoting relative to the shock absorber strut 114 and/or (ii) the shock absorber strut 114 compressing thereby causing outward movement of the link assembly 124.

The method comprises a step of detecting 208 this movement using the movement detector 132. The movement detector 132 comprises a sensor in the form of one or more pressure transducers which are arranged to sense the occurrence of compression or extension of the movement detector 132 by detecting a transient change in pressure. The step of detecting 208 therefore comprises sensing compression or extension of the movement detector 132 using the one or more pressure transducers. Detecting 208 also comprises providing an output signal on the basis of which it can be determined that movement has occurred.

The method comprises a step of the control system 134 receiving 210 the signal output from the one or more pressure transducers of the movement detector 132. In this embodiment the control system 134 receives a nil or baseline signal when there is no compression or extension of the moment detector 132, and a different signal during compression or extension. In embodiments the movement detector may generate a single pulse upon movement. In other embodiments the control system may additionally receive a signal corresponding to position, for example a measurement of the travel of the ends of the movement detector.

Finally the method comprises a step of the control system 134 determining 212, on the basis of the signal received, that there is aircraft weight on wheels. In this embodiment aircraft weight on wheels is determined to have occurred when the signal received from the one or more pressure transducers departs from the baseline signal by a threshold amount.

The method of the second embodiment may be a part of a method of slowing an aircraft. In which case there is a subsequent step of deploying 214 at least one means of slowing the aircraft when the control system determines there to be aircraft weight on wheels.

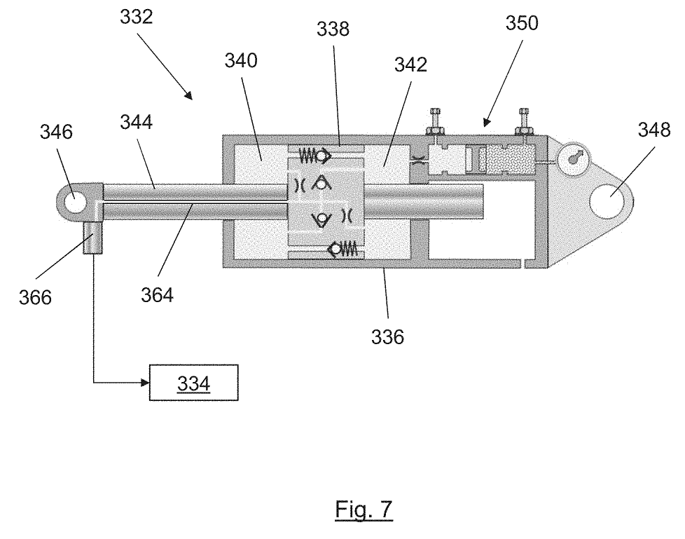

A movement detector 332 according to a third embodiment of the invention will now be described with reference to FIG. 7. Movement detector 332 comprises a cylinder 336 having an internal space which houses a piston 338. The piston 338 divides the internal space into a first chamber 340 and a second chamber 342. The first chamber 340 and the second chamber 342 are filled with a hydraulic fluid. A hydraulic accumulator 350 keeps the hydraulic fluid in the first and second chambers 340, 342 topped up and at a substantially constant average pressure (PA).

The piston 338 is received on a piston rod 344 which extends through both end walls of the internal space. Two apertures 346, 348 are located at opposing ends of the movement detector. A first aperture 346 being located on the piston rod and a second aperture being located on the cylinder 336. The movement detector 332 is pivotally mountable to the bogie and the link assembly via the apertures 346, 348.

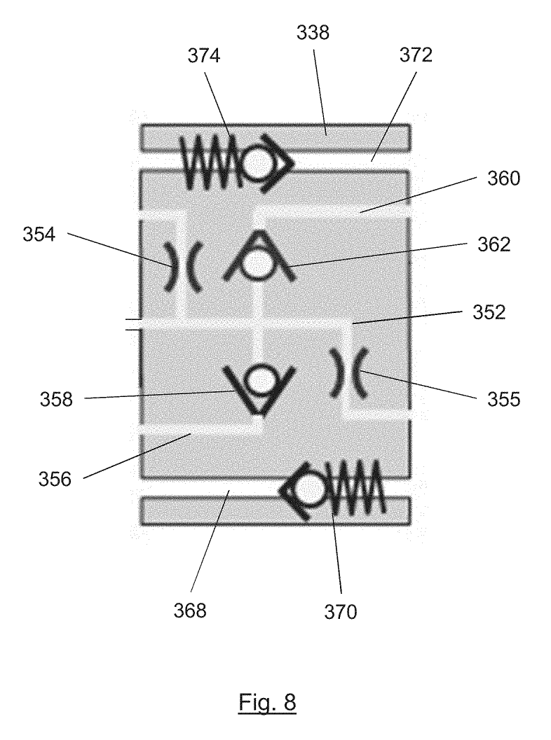

FIG. 8 shows an enlarged view of the piston 338. A flow restricted channel 352 extends through the piston 338 and puts the first chamber 340 into fluid communication with the second chamber 342. The flow restricted channel 352 comprises a first and a second restrictor 354, 355 in series which act to restrict the rate at which fluid can flow through the flow restricted channel 352.

A first non-return channel 356 connects the first chamber 340 with the flow restricted channel 352 at a point between the two restrictors 354, 355. The first non-return channel 356 contains a non-return valve 358 arranged to only permit fluid flow from the first chamber 340 into the flow restricted channel 352, not back again. A second non-return channel 360 connects the second chamber 342 with the flow restricted channel 352 at a point between the first restrictor 354 and the second restrictor 355. The second non-return channel 360 contains a non-return valve 362 arranged to only permit fluid flow from the second chamber 342 into the flow restricted channel 352, not back again.

A pressure transducer channel 364 runs through the piston rod 344 into the piston 338 and connects with the flow restricted channel 352 at a point between the first restrictor 354 and the second restrictor 355. A pressure transducer 366 is mounted to the piston rod 344 and is arranged to sense the pressure of the fluid in the pressure transducer channel 364. The pressure transducer 366 can be put in communication with a control system 334 comprising a signal processor.

A first pressure relief channel 368 comprising a first pressure relief valve 370 extends through the piston 338 to permit fluid flow from the first chamber 340 into the second chamber 342 when the pressure in the first chamber 340 exceeds a threshold pressure (the crack pressure, P_{C}) relative to the pressure in the second chamber 342. A second pressure relief channel 372 comprising a second pressure relief valve 374 extends through the piston 338 to permit fluid flow from the second chamber 342 into the first chamber 340 when the pressure in the second chamber 342 exceeds a threshold pressure relative to the pressure in the first chamber 340.

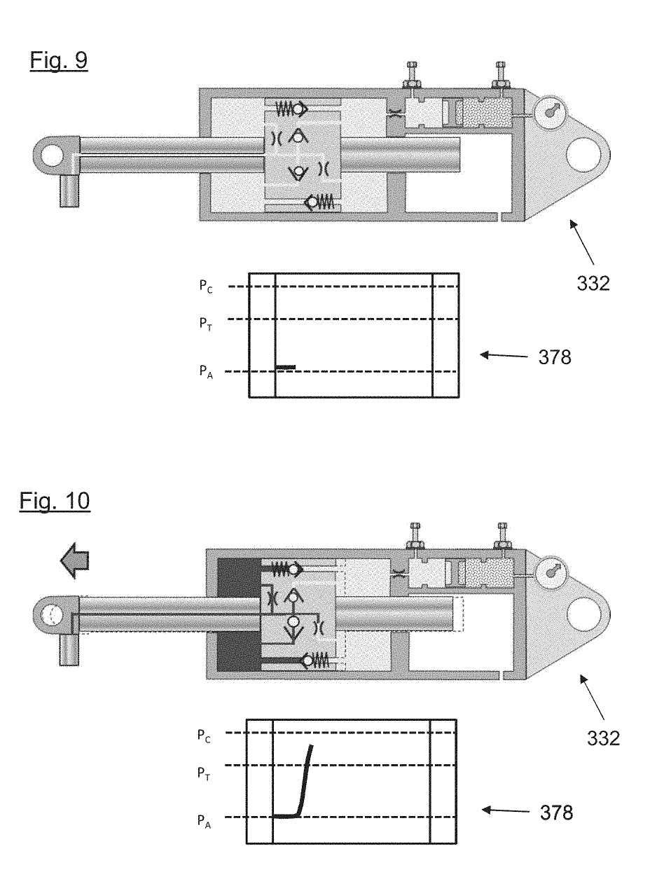

FIGS. 9 to 12 show how movement is detected upon movement of the piston 338 in the cylinder 336. FIG. 9 shows the movement detector 332 is prior to movement. The piston 336 is positioned in the middle of the cylinder 338 such that the first chamber 340 and second chamber 342 have approximately equal volumes (although it will be understood that the piston need not start in this position). The fluid in the chambers 340, 342 is held at the pressure of the accumulator.

FIG. 10 shows the piston 336 having moved in the direction of the first chamber 340. Such movement corresponds to an increase in length of the movement detector 338. In use, for example in the arrangement shown in FIG. 3, such movement is due to a movement of the bogie 120 relative to the link assembly 124. The reduction in volume of the first chamber 340 leads to an increase in the pressure of the fluid held therein. The first non-return valve 558 opens and fluid therefore flows into the flow restricted channel 352 via the first non-return channel 356 and (to a limited extent) via the first flow restrictor 354. The pressure of fluid in the pressure transducer channel 364 thus also increases. The pressure increase is detected by the pressure transducer 366 as shown in the graph 378 of pressure detected vs time.

The flow restrictors 354, 355 limit the rate of flow between the chambers such that the pressure of the fluid can build up to a level which is detectable by the transducer. If the restrictors 354, 355 do not limit flow rate between the first and second chambers 340, 342 enough, then then the pressure in the first chamber 340, and thus the pressure in the pressure transducer channel 364, may not increase to a level which is readily detectable by the transducer 366, even upon a fairly rapid movement of the piston 336. Conversely, if the flow is restricted too much, then the pressure may build up rapidly upon even slight movements of the piston 338 in the cylinder 336, such as may be caused by vibrations in the landing gear assembly. The rate of pressure build up may be affected by several other variable such as the compressibility of the fluid and the chamber size.

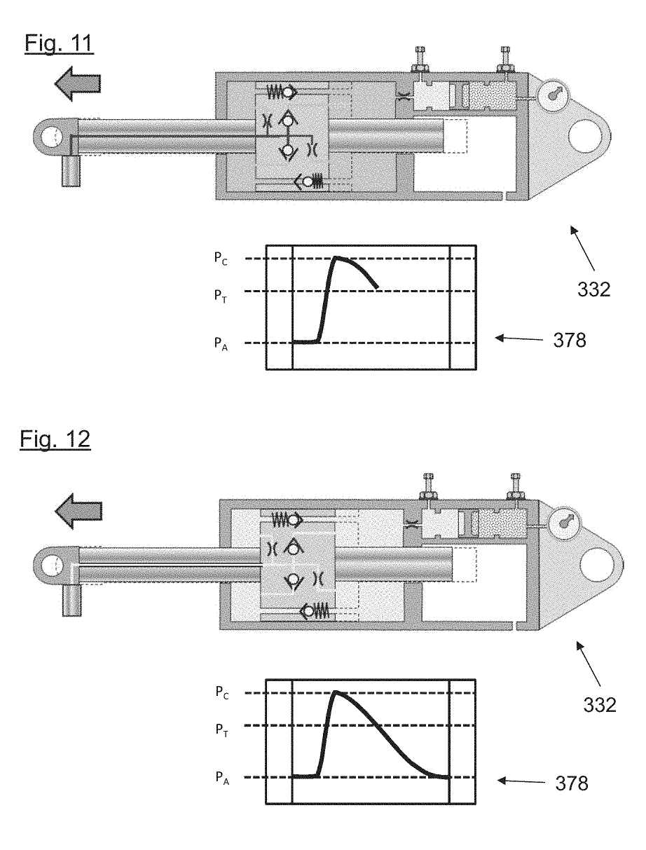

FIG. 11 shows the piston 336 having moved further in the direction of the first chamber 340 such that the pressure in the first chamber 340 has exceeded the threshold pressure of the first pressure relief valve 370. The diameter of the pressure relief channels 368, 372 exceeds the diameter of the flow restrictors 354, 355 and is such that the pressure difference between the first and second chambers 340, 342 can equalise more quickly than via the flow restricted channel 352 alone. This also allows the piston to move more quickly within the cylinder. In use this may reduce the forces and stress on the movement detector caused by rapid movement of the bogie upon touchdown. Should the threshold pressure of the first pressure relief valve 370 not have been met, the pressure would be left to equalise via the flow restricted channel 352 only. FIG. 12 shows the movement detector in its new position following the movement.

In the movement detector 332 high pressure fluid contained in the flow restricted channel 352 between the restrictors 354, 355 cannot quickly equalise via the first pressure relief channel 368 because the previously open first non-return valve 358 will close. Thus the fluid must flow out at a slower rate via the restrictors 354, 355. The pressure measured by the pressure transducer 366 therefore decays more slowly than if the pressure in the first chamber 340 was measured directly.

It will be appreciated that should the link assembly move relative to the bogie in the opposite direction, such that the piston moves in the direction of the second chamber, the process described above will repeat except it will be the second non-return valve 362 which opens to permit fluid to flows into the flow restricted channel 352, and the second pressure relief valve 374 which opens to allow the pressure to more quickly equalise.

When connected to an aircraft control system the control system may determine that movement is significant enough to be caused by aircraft weight on wheels only when the measured pressure exceeds a threshold pressure (P_{T}). The threshold pressure is preferably between the accumulator pressure (P_{A}) and the threshold pressure of the pressure relief valve (P_{C}). In alternative embodiments the movement detector may comprise its own signal processor which provides a discrete true/false signal while the pressure exceeds the threshold pressure. The aircraft control system may use the receipt of the signal to determine that there is aircraft weight on wheels.

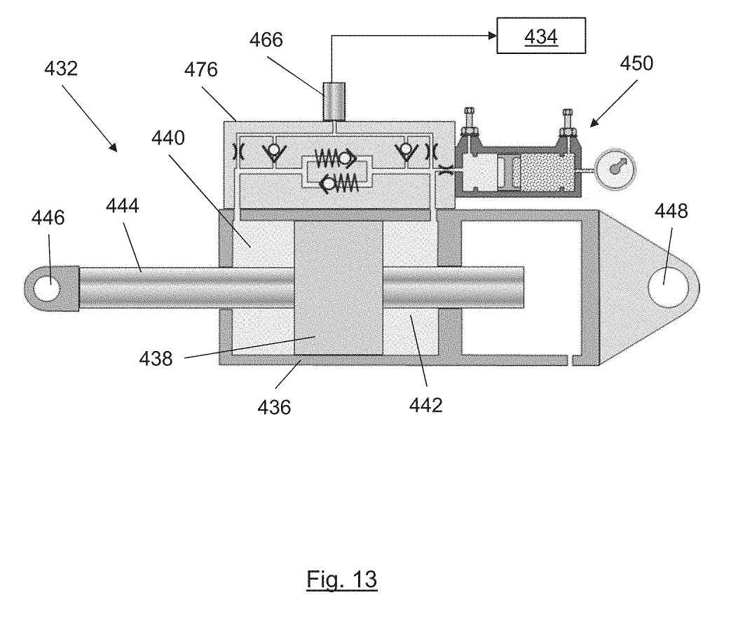

A movement detector 432 according to a fourth embodiment of the invention will now be described with reference to FIG. 13. Like the third embodiment, a cylinder 436 houses a piston 438 which divides an internal space of the cylinder 436 into a first chamber 440 and a second chamber 442. The piston 438 is received on a piston rod 444 which extends through both end walls of the internal space. Apertures 446, 448 on the piston rod and cylinder can be used to mount the movement detector 432 to a landing gear assembly.

In the fourth embodiment the movement detector comprises a detachable body 476 which is in fluid communication with the first chamber 440 and second chamber 442 by inlet/outlet ports proximate the end walls of the chambers 440, 442. The body 476 comprises a similar arrangement of valves and channels to the piston 336 of the third embodiment. Fluid flows through the valves in response to movement of the piston in a similar way to how fluid flows in the third embodiment. The difference being that movement of the piston 438 in this fourth embodiment forces fluid out of one chamber into the other chamber via the body rather than via the piston.

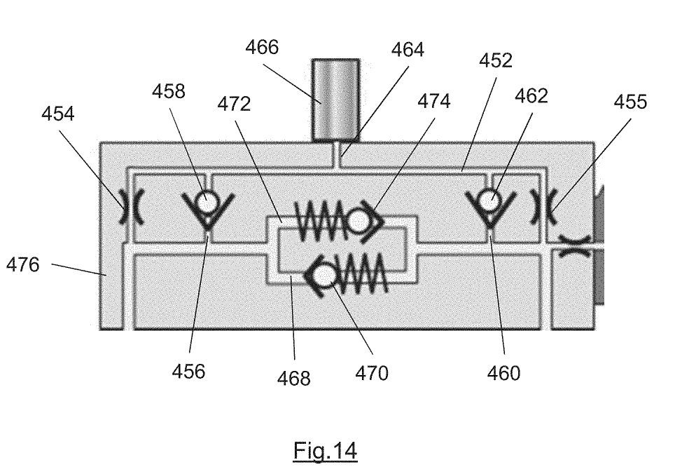

FIG. 14 shows an enlarged view of the body 476. A flow restricted channel 452 extends through the body 476 and puts the first chamber 440 into fluid communication with the second chamber 442. The flow restricted channel 452 comprises a first and a second restrictor 454, 455 in series which act to restrict the rate at which fluid can flow through the flow restricted channel 452.

A first non-return channel 456 comprising a first non-return valve 458 connects the first chamber 440 with the flow restricted channel 452 at a point between the two restrictors 454, 455. A second non-return channel 460 comprising a second non-return valve 462 connects the second chamber 442 with the flow restricted channel 452 at a point between the first restrictor 454 and the second restrictor 455.

A pressure transducer channel 464 runs into the top of the body 476 and connects a pressure transducer 466 with the flow restricted channel 452 at a point between the first restrictor 454 and the second restrictor 455. The pressure transducer 466 can be put in communication with a control system 434 comprising a signal processor.

A first pressure relief channel 468 comprising a first pressure relief valve 470 extends between the inlet/outlet ports of the body 476 to permit fluid flow from the first chamber 440 into the second chamber 442 when the pressure in the first chamber 440 exceeds a threshold pressure (the crack pressure) relative to the pressure in the second chamber 442. A second pressure relief channel 472 comprising a second pressure relief valve 474 extends between the inlet/outlet ports of the body 476 to permit fluid flow from the second chamber 442 into the first chamber 440 when the pressure in the second chamber 442 exceeds a threshold pressure relative to the pressure in the first chamber 440.

A hydraulic accumulator 450 keeps the hydraulic fluid in the first and second chambers 440, 442 topped up and at a substantially constant average pressure by feeding into the body 476, rather than directly into one of the chambers.

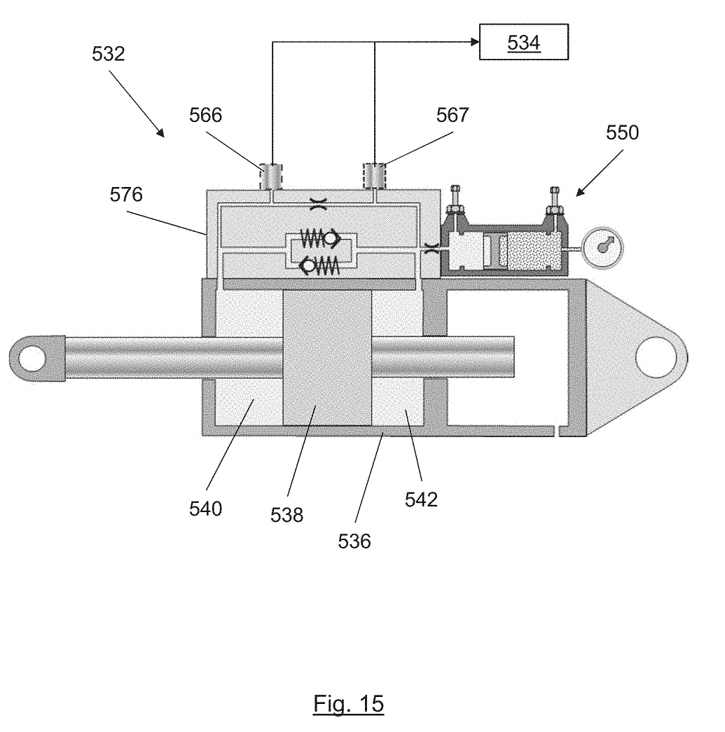

A movement detector 532 according to a fifth embodiment of the invention will now be described with reference to FIG. 15. The piston 538 and cylinder 536 are all arranged as per the fourth embodiment of the invention. A detachable body 576 comprises channels and valves which connect the first and second chambers 540, 542. A hydraulic accumulator 550 connects into the body 576 as per the fourth embodiment.

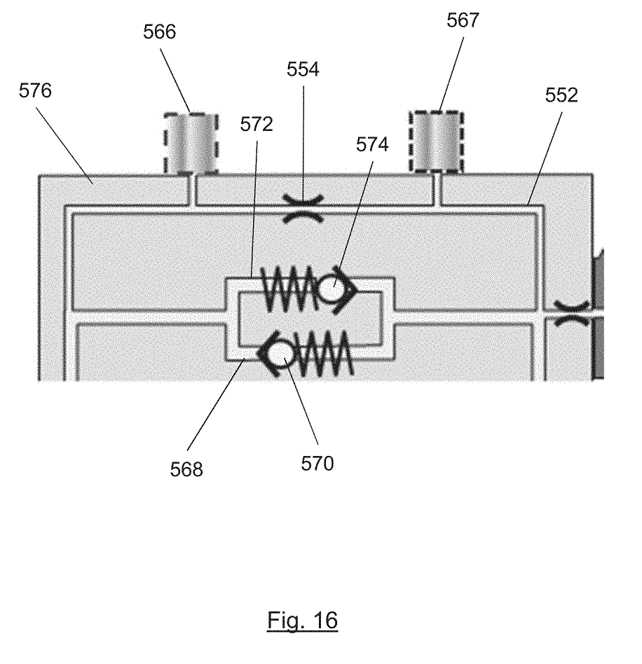

FIG. 16 shows an enlarged view of the body 576. The body 576 comprises a flow restricted channel 552 comprising a single restrictor 554. A first and a second transducer 566, 567 are arranged to measure the pressure of the fluid either side of the restrictor 554. Similarly to the fourth embodiment, two pressure relief channels 568, 572, having pressure relief valves 570, 574, extend between the inlet/outlet ports of the body 576.

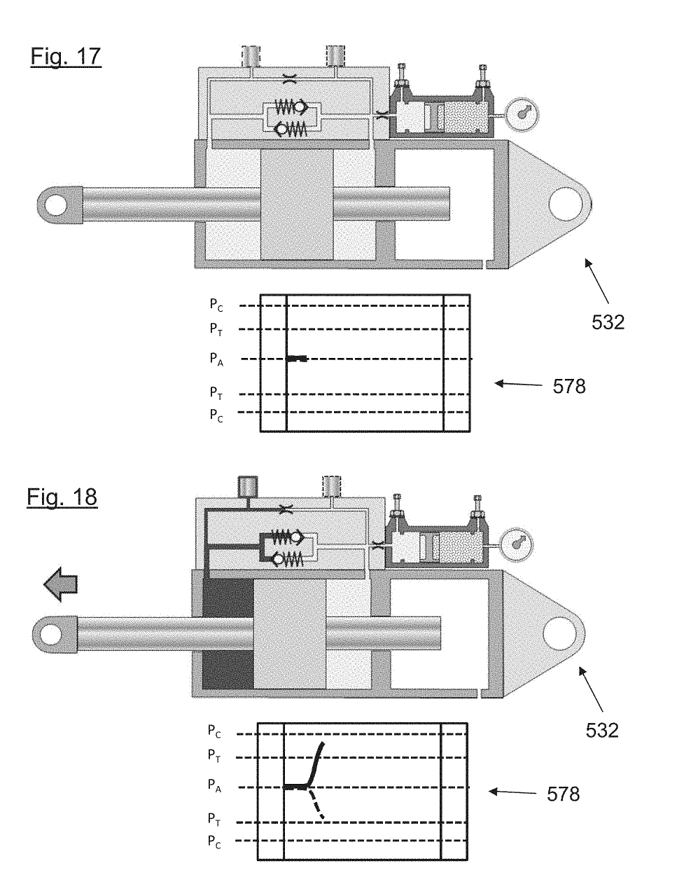

FIGS. 17 to 19 show how movement is detected upon movement of the piston 538 in the cylinder 536. FIG. 17 shows the movement detector 532 prior to movement. The piston 536 is positioned in the middle of the cylinder 538 such that the first chamber 540 and second chamber 542 have approximately equal volumes (although it will be understood that the piston need not start in this position). The fluid in the chambers 540, 542 is held at the pressure of the accumulator 550.

FIG. 18 shows the piston 536 having moved in the direction of the first chamber 540. Such movement corresponds to an increase in length of the movement detector 538. In use, for example in the arrangement shown in FIG. 3, such movement is due to a movement of the bogie 120 relative to the link assembly 124.

The reduction in volume of the first chamber 540 leads to an increase in the pressure of the fluid held therein. The fluid therefore flows into the flow restricted channel 552. The flow restrictor 554 limits the rate of fluid flow into the second chamber 542 which therefore causes the pressure in the first chamber 540 to build up. The increase in pressure is measured by the first transducer 566. Conversely, the increase in volume of the second chamber 542 leads to a decrease in the pressure of the fluid held therein. The decrease in pressure is similarly detected by the second transducer 567. Graphs 578 show the pressure detected by the transducers vs time (the solid line corresponding to the first transducer 566 and the dashed line corresponding to the second transducer 567).

The use of two pressure transducers 566, 567 makes it possible to detect the direction of movement of the piston 538 within the cylinder 536, and therefore direction of movement of the bogie relative to the link assembly.

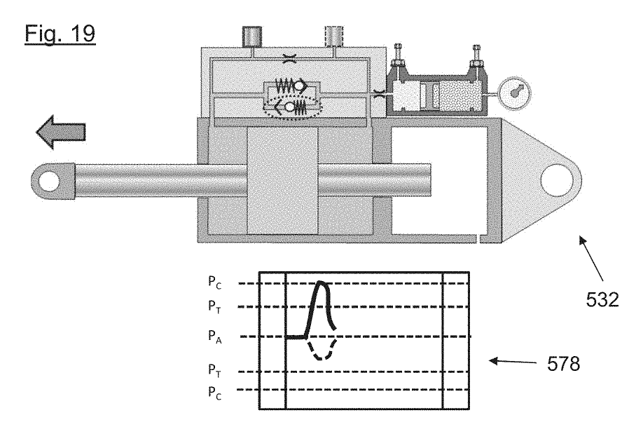

FIG. 19 shows the piston 536 having moved further in the direction of the first chamber 540 such that the pressure in the first chamber 540 has exceeded the threshold pressure (PC) of the first pressure relief valve 570 thereby allowing fluid to flow through the first pressure relief channel 568. The pressure difference between the first and second chambers equalises more quickly via the first pressure relief channel 568. The pressure detected by the pressure transducers is likely to return to the accumulator pressure (PA) faster than in the third and fourth embodiments as the fluid whose pressure is being measured does not get trapped between two restrictors.

When connected to an aircraft control system the control system may determine that movement is significant enough to be caused by aircraft weight on wheels only when the measured pressure exceeds a threshold pressure (PT). The threshold pressure is preferably between the accumulator pressure (PA) and the threshold pressure of the pressure relief valve (PC). In alternative embodiments the movement detector may comprise its own signal processor which provides a discrete true/false signal while the pressure exceeds the threshold pressure. The aircraft control system may use the receipt of the signal to determine that there is aircraft weight on wheels.

It will again be appreciated that should the link assembly move relative to the bogie in the opposite direction, such that the piston moves in the direction of the second chamber, the process described above will repeat except it will be the second transducer 567 which detects an increase in pressure, the first transducer 566 which detects a decrease in pressure, and the second pressure relief valve 574 which opens to allow the pressure to more quickly equalise.

Whilst the present invention has been described and illustrated with reference to particular embodiments, it will be appreciated by those of ordinary skill in the art that the invention lends itself to many different variations not specifically illustrated herein. Some examples of such variations will now be described by way of example only.

In another embodiment of the invention there is provided a movement detector similar to that described in relation to the fifth embodiment. Instead of the hydraulic network being located in the body, the hydraulic network is located in the piston. In another embodiment of the invention, the movement detector additionally detects movement of the piston within the cylinder, and therefore movement of the link assembly relative to the bogie, by using a sensor which is arranged to detect the flow of fluid (for example by detecting fluid flow speed) through one or more of the channels. In embodiments where the fluid is substantially incompressible there may be very little or no compression (reduction in volume) of the fluid when force is applied to the piston as a result of aircraft weight on wheels. Thus the piston may move very little, and only at a rate corresponding to the rate at which fluid can flow through the flow restricted channel, until the pressure relief valves open to allow fluid to flow more quickly between the chambers.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An aircraft landing gear assembly,
the aircraft landing gear assembly comprising: a shock absorber strut, a bogie, a link assembly, and a movement detector;
wherein the shock absorber strut comprises upper and lower telescoping parts, the upper telescoping part being connectable to the airframe of an aircraft and the lower telescoping part being connected to the bogie such that the bogie may adopt different pitch angles;
the link assembly extends between the upper and lower telescoping parts, such that relative movement between the upper and lower telescoping parts causes relative movement between parts of the link assembly; and
the movement detector is arranged to detect movement of the link assembly relative to the bogie;
wherein the movement detector comprises:
a piston slidably received within a cylinder, arranged such that relative movement between the link assembly and the bogie causes relative movement of the piston within the cylinder;
fluid which flows as a result of the relative movement between the piston and the cylinder; and
one or more pressure transducers arranged to sense a pressure change in the fluid;
wherein relative movement between the link assembly and the bogie is detected by the one or more pressure transducers detecting a change in pressure due to movement of the piston within the cylinder.

2. The aircraft landing gear assembly according to claim 1, wherein the cylinder comprises a first chamber, and the first chamber being in fluid communication with a second chamber, and the one or more pressure transducers being arranged to detect when the pressure changes in the first chamber and/or the second chamber.

3. The aircraft landing gear assembly according to claim 2, wherein the cylinder comprises the second chamber, and the first and second chambers being separated by the piston.

4. The aircraft landing gear assembly according to claim 2, wherein the first chamber and the second chamber are in fluid communication by a flow restricted channel; and further comprising:
one or more pressure relief channels are arranged to permit (i) fluid flow from the first chamber into the second chamber when the pressure in the first chamber exceeds a first threshold pressure relative to the pressure in the second chamber and (ii) fluid flow from the second chamber into the first chamber when the pressure in the second chamber exceeds a second threshold pressure relative to the pressure in the first chamber.

5. The aircraft landing gear assembly according to claim 4, wherein the movement detector comprises a first pressure transducer being arranged to measure the pressure in the first chamber by measuring the pressure at one side of a flow restricted location within the flow restricted channel and a second pressure transducer being arranged to measure the pressure in the second chamber by measuring the pressure at the other side of the flow restricted location.

6. The aircraft landing gear assembly according to claim 4,
wherein the flow restricted channel comprises two flow restricted locations, the one or more pressure transducers being arranged to measure the pressure between the two flow restricted locations; and
wherein the movement detector further comprises (i) a first non-return channel connecting the first chamber with the flow restricted channel at a location between the two flow restricted locations, the first non-return channel comprising a non-return valve arranged to only permit fluid flow from the first chamber into the flow restricted channel; and (ii) a second non-return channel connecting the second chamber with the flow restricted channel at a location between the two flow restricted locations, the second non-return channel comprising a non-return valve arranged to only permit fluid flow from the second chamber into the flow restricted channel.

7. The aircraft landing gear assembly according to claim 4, wherein one or more of the following are located in the piston: (i) the one or more pressure relief channels, and (ii) the flow restricted channel.

8. The aircraft landing gear assembly according claim 7, wherein the movement detector further comprising a piston rod connected to the piston, and wherein the one or more pressure transducers are in fluid communication with the first and/or second chambers via one or more channels in the piston rod.

9. The aircraft landing gear assembly according to claim 4, further comprising a body detachably mounted to the cylinder, and one or more of the following being located in the body: (i) the one or more pressure relief channels, and (ii) the flow restricted channel.

10. The aircraft landing gear assembly according to claim 1, wherein the movement detector further comprises:
a signal processor being arranged to determine that there is aircraft weight on wheels when the pressure change measured by the one or more pressure transducers exceeds a threshold amount.

11. The aircraft landing gear assembly according claim 10, wherein the signal processor is arranged to generate a binary output indicating whether or not there is aircraft weight on wheels.

12. An aircraft including one or more of the landing gear assembly according to claim 1.

13. A method of detecting aircraft weight on wheels during a landing of an aircraft, wherein the aircraft comprises:
a control system and a landing gear assembly;
the landing gear assembly comprises: a shock absorber strut, a bogie, a link assembly, and a movement detector;
the shock absorber strut comprises an upper and a lower telescoping parts, the upper part being connected to the airframe of an aircraft and the lower part being connected to the bogie such that the bogie may adopt different pitch angles;
the link assembly extends between the upper and lower telescoping parts, such that relative movement between the upper and lower telescoping parts causes relative movement between parts of the link assembly;
the bogie supports at least one wheel on at least one axle; and
wherein the movement detector comprises: a piston slidably received within a cylinder, wherein movement of the piston within the cylinder causes fluid to flow in the movement detector, one or more pressure transducers arranged to sense a local pressure change in the fluid;
the method comprising the steps of:
the link assembly adopting an initial position relative to the bogie at a point in time that is after the landing gear assembly has been deployed for landing and before the aircraft has touched down;
the link assembly moving relative to the bogie during touchdown of the least one wheel thereby causing the piston to move within the cylinder and there to be a transient change in pressure in the fluid;
the one or more pressure transducers detecting the change in pressure;
the control system receiving a signal from the one or more pressure transducers, the signal being indicative of the change in pressure; and
the control system determining, on the basis of the signal, that there is aircraft weight on wheels.

14. The method according to claim 13, wherein the step of the control system determining that there is aircraft weight on wheels comprises the control system determining whether the pressure has exceeded a threshold amount.

15. The method according to claim 13, wherein the signal indicative of a change in pressure is in the form of a pulse.

16. The method of claim 13 further comprising:
deploying at least one device to slow the aircraft when the control system determines there is aircraft weight on wheels.

17. (canceled)

18. A movement detector for detecting the weight on wheels condition of an aircraft landing gear, wherein the movement detector comprises:
a piston slidably received within a cylinder, the cylinder comprising a first chamber, the first chamber being in fluid communication with a second chamber, and
one or more pressure transducers arranged to detect a pressure change in the fluid,
wherein, in use, the movement detector is arranged such that movement of the piston relative to the cylinder from a neutral position is caused by movement of parts of the aircraft landing gear caused by one or more wheels contacting the ground, and movement of the piston relative to the cylinder causes a pressure change in the first chamber and/or the second chamber,
whereby the weight on wheels condition is, in use, detected by the one or more pressure transducers arranged to detect a pressure change in the fluid.

19. (canceled)
